(19) United States
(12) Patent Application Publication
(10) Pub. No.: US 2015/0227331 A1
(43) Pub. Date: Aug. 13, 2015

(54) SYSTEM AND METHOD FOR MONITORING PRINTER-RELATED DATA ON USB CABLES

(71) Applicants: Marvin D. Scaff, Tampa, FL (US); Patrick Adesso, Tampa, FL (US); Gideon Hecht, Tampa, FL (US); Jill Castellenti, Dade City, FL (US)

(72) Inventors: Marvin D. Scaff, Tampa, FL (US); Patrick Adesso, Tampa, FL (US); Gideon Hecht, Tampa, FL (US); Jill Castellenti, Dade City, FL (US)

(21) Appl. No.: 14/622,011

(22) Filed: Feb. 13, 2015

Related U.S. Application Data
(60) Provisional application No. 61/939,403, filed on Feb. 13, 2014.
(60) Provisional application No. 61/939,365, filed on Feb. 13, 2014.
(60) Provisional application No. 61/939,374, filed on Feb. 13, 2014.
(60) Provisional application No. 61/939,388, filed on Feb. 13, 2014.
(60) Provisional application No. 61/939,419, filed on Feb. 13, 2014.

(51) Int. Cl. G06F 3/12

(52) U.S. Cl. CPC G06F 3/1236; G06F 3/123; G06F 3/1204

(57) ABSTRACT

Provided is a computer-implemented system and method for monitoring printer-related data on USB cables. A USB-compatible device is placed in-line between a non-networked computer and a printer and monitors the line for print-related data. Once detected, the print-related data is transmitted via a radio frequency to a base station. The base station subsequently compiles the print-related data and relays the data to a printer reporting system.

### RELATED APPLICATION DATA

This application claims priority to U.S. Provisional Patent Application Ser. No. 61/939,403, filed Feb. 13, 2014, entitled “System and Method for Monitoring Printer-Related Data on USB Cables,” U.S. Provisional Patent Application Ser. No. 61/939,365, filed Feb. 13, 2014, entitled “System and Method for the Passive Monitoring and Reporting of Printer-Related Data on USB Cables,” U.S. Provisional Patent Application Ser. No. 61/939,374, filed Feb. 13, 2014, entitled “System and Method for the Near Field Communication Pairing of Components of a Printer-Related Data Reporting System,” U.S. Provisional Patent Application Ser. No. 61/939,388, filed Feb. 13, 2014, entitled “System and Method for the Barcode Pairing of Components of a Printer-Related Data Reporting System,” and U.S. Provisional Patent Application Ser. No. 61/939,419, filed Feb. 13, 2014, entitled “System and Method for the Passive Monitoring and Reporting of Network Content on USB Cables,” the contents of which are fully incorporated by reference herein for all purposes.

### TECHNICAL FIELD

This disclosure relates to a computer-implemented system and method for monitoring printer related data on USB cables and relaying the data to a printer reporting system.

### BACKGROUND OF THE INVENTION

Methods for detecting and compiling data relating to printer actions are known in the industry. Existing methods, however, often require the use of a designated computer within an established computer network that utilizes installed software for monitoring print events on the network. These methods suffer from several limitations, including the reliance on network administrators to perform a complex installation protocol, the need for customization, the need for compatibility and functionality within a variety computer operating system environments, the use of a client's hardware and network to gather and report data, and the use of internal client bandwidth to report printer-related data.

Thus, a need exists in the industry for overcoming the limitations associated with the use of installed software on an existing network computer for monitoring printer-related data.

### SUMMARY OF THE INVENTION

This disclosure provides for a system and method for monitoring printer related data and relaying the data to a printer-related data reporting system.

The disclosed system has several important advantages. For example, the present disclosure provides a system for monitoring printer data that is more user friendly, reliable, dependable, and easier to install than existing print data monitoring systems.

Another advantage of the present system is that it eliminates the need for installing software on existing computers for monitoring print job related data.

Yet another advantage of the present system is eliminating the need for administrative access to computers to install the system.

Still yet another possible advantage of the disclosed system is providing hardware powered by a USB line, eliminating the need for an external power supply and decreasing the likelihood that the system will go offline as the result of a loss of external power.

Another advantage of the present system may include permitting the collection of more robust print job related information, including but not limited to device specific information, number of pages printed, and mono and/or color toner levels.

Yet another advantage of the present disclosure includes providing a system that allows the hardware's internal software to be updated, configured, and or expanded remotely.

Still yet another advantage of the present invention is the ability to monitor printer-related data on a non-networked printer and computer.

### BRIEF DESCRIPTION OF THE DRAWINGS

For a more complete understanding of the present disclosure and its advantages, reference is now made to the following descriptions, taken in conjunction with the accompanying drawings, in which:

FIG. 1 is a diagram depicting the various components of an embodiment of the present invention.

FIG. 2 is a flow chart depicting a computer-implemented method and system of the present disclosure.

Similar reference numerals refer to similar parts throughout the several views of the drawings.

### DETAILED DESCRIPTION OF THE PREFERRED EMBODIMENT

The present invention relates to a system and method for monitoring printer-related data on USB cables and relaying the data to a printer reporting system via a base station, wherein the monitoring is performed using hardware affixed to a USB cable. Alternatively, the present invention relates to a system and method for monitoring printer-related data on USB cables and relaying the data to a printer reporting system, wherein the monitoring is performed using hardware affixed to a USB cable, the hardware connecting directly over the internet to the printer reporting system, thereby eliminating the need for a base station. The various components of the present invention, and the manner in which they interrelate, are described in greater detail hereinafter.

The computer-implemented method and system may include, but are not limited to, the following steps. It will be appreciated by one skilled in the art that the order of steps presented herein may be performed in a different order. It will also be appreciated by one skilled in the art that the method and system described herein for monitoring and reporting printer-related data may include all, some, or none of the steps described herein.

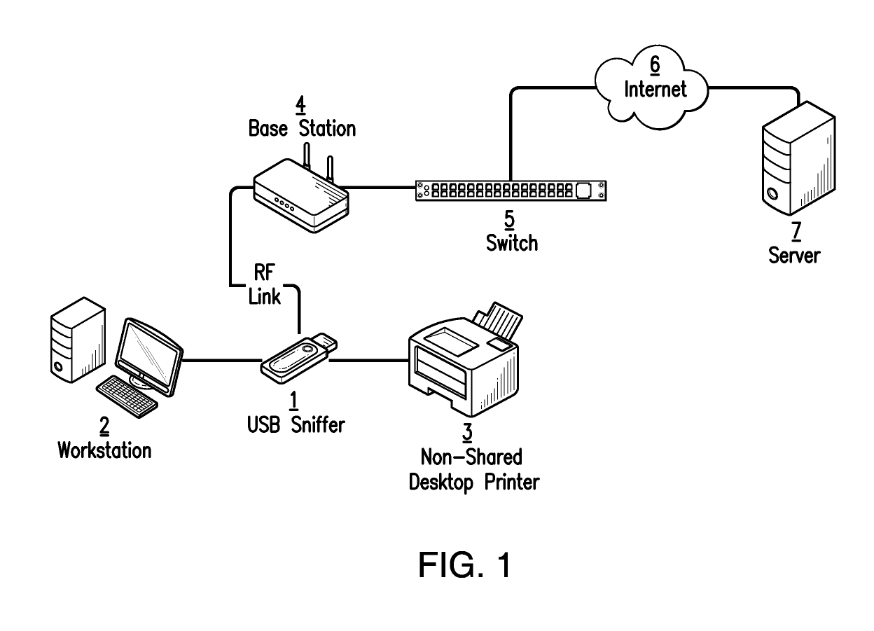

Initially with reference to FIG. 1, the system may include placing a device along a USB line between a personal computer and a non-networked printer. The device may include both male and female USB connectors for in-line connectivity. In one embodiment of the present invention the device is a USB-compatible device capable of transmitting radio frequency bandwidth outside of an existing computer network. The device passively monitors the USB line to detect printer actions, and reports data relating to printer actions to a base station via a mesh network. The data is reported to the base station via the radio frequency bandwidth. Data relating to printer actions may include, but is not limited to, the number of pages printed, color, ink or toner density, and other data. In one embodiment of the present invention, the system gathers data from outside of an existing network. The base station subsequently aggregates the data and uploads the data to a server over the internet. In an alternative embodiment of the present invention, the USB device connects directly to the internet via radio frequency bandwidth, WiFi, cellular radio, Bluetooth, or other known communication technology and uploads the data to a server, thereby eliminating the need for a base station. The system does not require the installation of software on an associated computer. Further, the system does not require user-specific configuration because it is supplied pre-configured to monitor print jobs and printer-related data.

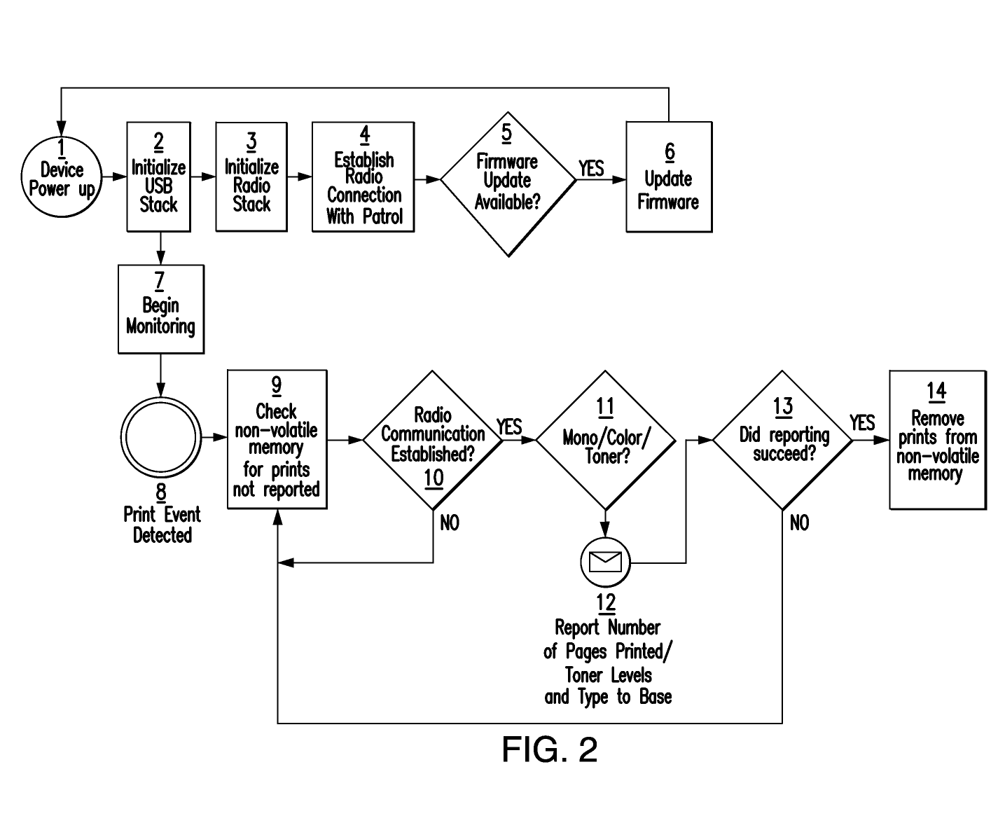

With reference to FIG. 2, the system and method disclosed herein allows for the remote update of its application code, or firmware, by initializing the USB stack after power up, initializing its radio software stack, and checking with the base station to determine whether a firmware update exists. If a firmware update exists, the system updates the firmware. Once an update is complete or the device determines that an update is not required, it begins monitoring the USB data. Once a print event is detected, the device checks its non-volatile memory for previous print events that were detected but not reported, and verifies that radio communication exists with the base station. If radio communication exists, the device reports the print event details to the base station and flags the event as reported. If appropriately flagged, the unit then removes the print event details from the non-volatile memory and returns to the monitoring state. This entire process is completed without the need for the device to enumerate on the host computer.

It will be understood by those of skill in the art that flowcharts and block diagrams herein described may illustrate architecture, algorithms, functionality, and operation of possible implementations of systems, methods and computer program products according to various embodiments. Therefore, it will be understood that each block in the flowchart or block diagram may represent a module, segment, or portion of code, which comprises one or more executable computer program instructions for implementing the specified logical function or functions. Further, some implementations may include the functions in the blocks occurring out of the order as herein presented. By way of non-limiting example, two blocks shown in succession may be executed substantially concurrently, or the blocks may at times be executed in the reverse order, depending upon the functionality involved. It will also be noted that each block of the block diagrams and flowcharts, and combinations of blocks in the block diagram and flowchart illustrations, may be implemented by special purpose hardware-based systems that perform the specified functions or acts, or combinations of special purpose hardware and computer program instructions.

The system includes one or more processing devices, which may be a computer processing unit, and could be a single central processing unit, or a number of processing units configured to operate either in sequence or in parallel. The processing device can be configured to execute software processes which implement the steps disclosed herein. The system may also include a memory capable of storing the steps necessary for a processing device to implement the steps disclosed herein. This memory could be in the form of memory resident within the processing device or in the form of standalone memory coupled to the processing unit via a communication path, such as a bus or a network.

Although this disclosure has been described in terms of certain embodiments and generally associated methods, alterations and permutations of these embodiments and methods will be apparent to those skilled in the art. Accordingly, the above description of example embodiments does not constrain this disclosure. Other changes, substitutions, and alterations are also possible without departing from the spirit and scope of this disclosure.

What is claimed is:

1. A method for monitoring printer-related data on USB cables with a USB device, the method comprising:
powering up a USB device;
initializing a USB stack associated with the USB device;
initializing a radio software stack associated with the USB device;
establishing a radio connection between the USB device and a base station; and
querying the base station by the USB device to determine whether a firmware update exists, wherein if a firmware update exists, updating the firmware.

2. The method as described in claim 1, further comprising monitoring USB data by the USB device.

3. The method as described in claim 2, further comprising detecting a print event by the USB device.

4. The method as described in claim 3, further comprising checking a non-volatile memory for at least one prior unreported print event.

5. The method as described in claim 4, further comprising verifying radio communication exists between the USB device and the base station.

6. The method as described in claim 5, further comprising reporting the print event to the base station by the USB device.

7. The method as described in claim 6, wherein the reporting the print event includes reporting at least one of a number of pages printed, a toner level, an ink level, and a print type.

8. The method as described in claim 7, further comprising flagging the print event as reported.

9. The method as described in claim 8, further comprising removing the print event from the non-volatile memory.

10. A method for monitoring printer-related data on USB cables with a USB device, the method comprising:
powering up a USB device;
initializing a USB stack associated with the USB device;
initializing a wireless software stack associated with the USB device; and
establishing a connection between the USB device and a system.

11. The method as described in claim 10, wherein the establishing a connection includes establishing a connection over at least one of a radio frequency bandwidth, a WiFi network, a cellular radio network, and a Bluetooth network.

12. The method as described in claim 11, further comprising querying the system by the USB device to determine whether a firmware update exists, wherein if a firmware update exists, updating the firmware.

13. The method as described in claim 12, further comprising monitoring USB data by the USB device.

14. The method as described in claim 13, further comprising detecting a print event by the USB device.

15. The method as described in claim 14, further comprising checking a non-volatile memory for at least one prior unreported print event.

16. The method as described in claim 15, further comprising verifying communication exists between the USB device and the system.

17. The method as described in claim 16, further comprising reporting the print event to the system by the USB device.

18. The method as described in claim 17, wherein the reporting the print event includes reporting at least one of a number of pages printed, a toner level, an ink level, and a print type.

19. The method as described in claim 18, further comprising flagging the print event as reported.

20. The method as described in claim 19, further comprising removing the print event from the non-volatile memory.
